(19) United States
(12) Patent Application Publication
(10) Pub. No.: US 2004/0233281 A1
(43) Pub. Date: Nov. 25, 2004

(54) Visual and audible surveillance system, using CATV cable plant distribution equipment, that enables the public to monitor, on television receivers, "at risk" areas or facilities 24 hours per day 7 days per week

(76) Inventor: Vincent Ronald Tolmei, Concord, CA (US)

Correspondence Address: Ron Tolmei, Suite 32, 1399 Ygnacio Valley Road, Walnut Creek, CA, 94598, US

(21) Appl. No.: 10/441,486

(22) Filed: May 20, 2003

(51) Int. Cl. H04N 7/18

(52) U.S. Cl. 348/143

(57) ABSTRACT

The use of television receivers, and CATV cable plants as a means of distribution, to provide 24 hours per day 7 days per week (24×7) surveillance of “at risk” areas, or facilities, that can be viewed by the public is presented. The system enables hundreds, perhaps even thousands, of local area residents with television receivers to view areas or facilities, such as public utilities, water processing plants, reservoirs, electrical substations, communication sites or parks, that are often subject to attacks of terrorism child molestation, vandalism, theft and the like. The areas can be viewed 24×7 by simply selecting a channel on a television receiver or by simultaneously observing the area with a picture in picture (PIP) display on television receivers with that capability. This gives law enforcement the eyes and ears of television's entire viewing audience 24. hours a day 7 days a week with instant reporting of “at risk” events before or as they occur.

### CROSS-REFERENCE TO RELATED APPLICATIONS

References Cited

U.S. Patent Documents

| | | | |
|---|---|---|---|
| 4,864,613 | Sep. 5, 1989 | Van Cleave | 380/220. |
| 6,061,604 | May 9, 2000 | Russ, et. al | 700/90. |
| 6,011,579 | Jan. 4, 2000 | Newlin | 348/14.08. |
| 6,070,148 | May 30, 2000 | Mori et al. | 705/26. |
| 4,670,739 | Jun. 2, 1987 | Kelly, Jr. | 340/539. |
| 5,774,825 | Jun. 30, 1998 | Reynolds | 701/207 |
| 6,141,682 | Oct. 31, 2000 | Barker | 709/217 |

### BACKGROUND OF THE INVENTION

1. Field of the Invention

This invention relates to the use of television receivers, and cable television (CATV) cable plant distribution systems, to provide 24 hours per day 7 days per week (24×7) surveillance by the public of areas and facilities that are “at risk”. The system enables hundreds perhaps even thousands of local area residents with television receivers to view areas and facilities, such as public utilities, water processing plants, reservoirs, electrical substations, communication sites or parks, that are often subject to attacks of terrorism, child molestation, vandalism, theft and the like. These areas or facilities can be visually and audibly monitored using low cost commercially available television cameras, such as charge-coupled devices (CCD), with composite video and audio capabilities. The areas can be viewed 24×7 by simply selecting a channel on a television set or by simultaneously observing the area with a picture in picture (PIP) display on television receivers with that capability. This gives law enforcement the eyes and ears of television's entire viewing audience 24 hours a day 7 days a week with instant reporting of “at risk” events before or as they occur.

The system can be installed country wide on a site by site basis in selected area locations, uses existing technology with only minor modifications, does not require governmental approval, and is compatible with all forms of cable television standards. Additionally the system is compatible with, or may be adapted for future use to, bi-directional operation to control camera observation areas if so desired or return information to the cable company, although these are not required for normal operation. Also, cameras can be changed or modified to have low light level or infrared capabilities to detect heat or movement at any time without modification to the system. Depending on the operational requirements the signals from these cameras can be programmed to transmit only when there is a change in the picture density, movement or temperature change in the field of view.

2. Discussion of Background

In light of the increased activity of terrorism, child kidnapping, molestation, and crime in general there is an immediate need to expand surveillance to protect us from these egregious acts. The government has expanded its use of conventional means of protection with the use of electronic security systems and supplemental guards at public facilities like airports, bridges, and such. Unfortunately electronic security systems themselves are not sophisticated enough to replace even an unskilled observer's ability to detect and thwart crimes. Therefore the emphasis has been to provide human guards, with their ability to think and adapt to the situation at hand, as the eyes and ears of law enforcement. This, one pair of eyes and ears, solution however is not a cost-effective way to monitor the thousands of areas and facilities that need to be under surveillance 24 hours a day 7 days week.

There have been many attempts to provide audio and visual surveillance examples of which are shown in the prior art apparatus contained U.S. Pat. No. 4,670,739 issued Jun. 2, 1987. Other types of surveillance apparatus are shown in U.S. Pat. No. 6,070,148 issued May 30, 2000, U.S. Pat. No. 4,864,613 issued Sep. 5, 1989, U.S. Pat. No. 6,061,604 issued May 9,2000, U.S. Pat. No. 6,011,579 issued Jan. 4, 2000, U.S. Pat. No. 6,141,682, issued Oct. 31, 2000, and U.S. Pat. No. 5,774,825, issued Jun. 39, 1998.

Inherent in the design of these systems is the fundamental problem of viewing sites by small selected groups, inability to distribute video signals to large populations, and compatibility with existing mass, or CATV, distribution systems. This is because each system does not have the installed global capability to monitor multiple sites and distribute video signals to multiple viewers using existing low cost and commercially available television receivers and already developed, and installed, electronic distribution equipment. These special purpose systems are designed for unique applications and therefore do not have the capability of mass distribution and use of existing equipment that is paramount to meet the needs of law enforcement in a timely and cost-effective manner.

The present invention's advantages are that: The mass distribution of video and audio signals via CATV is already installed world wide, the monitoring equipment used is existing low cost television receivers that do not require modification, virtually millions of viewers can simultaneously monitor selected sites for criminal activity without interfering with commercial broadcasts using existing picture-in-picture technology or by simply selecting the television channel that carries the monitored signals. Additionally, the electronic equipment necessary to monitor and translate the sites into a CATV format is low cost, readily available, fault tolerant, and will visually annunciate failure, tampering, or sabotage. Further, and most importantly the system can be installed on a site-by-site basis with minimal design and development efforts in a matter of days—which is tantamount to society's needs.

### BRIEF SUMMARY OF THE INVENTION

According to the present invention, a visual and audible surveillance system using television receivers and CATV plant equipment as a means of distribution is provided. The apparatus has television cameras, microphones, radio frequency modulators, signal combiners, television receivers, and associated equipment suitable for a surveillance area to be monitored 24 hours a day 7 days a week. Each set of equipment is installed at selected sites, is independent of other sites, and can operate as a stand-alone system not requiring interaction with other sites. Each site television camera and microphone monitors the area under surveillance and transmits audio and video signals to a radio frequency (RF) modulator that converts the signals into a cable television (CATV) recognizable RF television channels that are not used by the existing CATV system. These RF signals are then sent to a signal combiner that combines these RF signals with the existing CATV RF signals for distribution to all viewers in that distribution zone. CATV subscribers, or other authorized personnel and agencies, selecting the surveillance channel on their television receivers, perform 24x7 monitoring of surveillance areas. If simultaneous viewing of CATV channels and surveillance channels is desired this can be accomplished by using the televisions picture-in-picture (PIP) capabilities with either the television's second RF tuner or using a videocassette recorder to convert the RF signal to composite video and audio that can be viewed and heard on most television receivers.

In the preferred embodiment of the invention, the television camera and microphone are located at or near the site to be surveyed and by way of coaxial cable, or alternate means, connected to the RF modulator. The surveillance system is modular and can be housed in the CATV's storage area where the line extender or distribution amplifier is housed or at the surveillance site. Electrical power to the system can be supplied from existing CATV equipment or, alternately, supplied by external power supplies. In another embodiment, the entire surveillance system is one piece and resembles that of the preceding embodiment except it is fabricated in a single module.

Other objects of the present invention will become apparent upon reading the following specification and referring to the accompanying drawings in which similar characters of reference represent corresponding parts in each of the several views.

### BRIEF DESCRIPTION OF THE SEVERAL VIEWS OF THE DRAWINGS

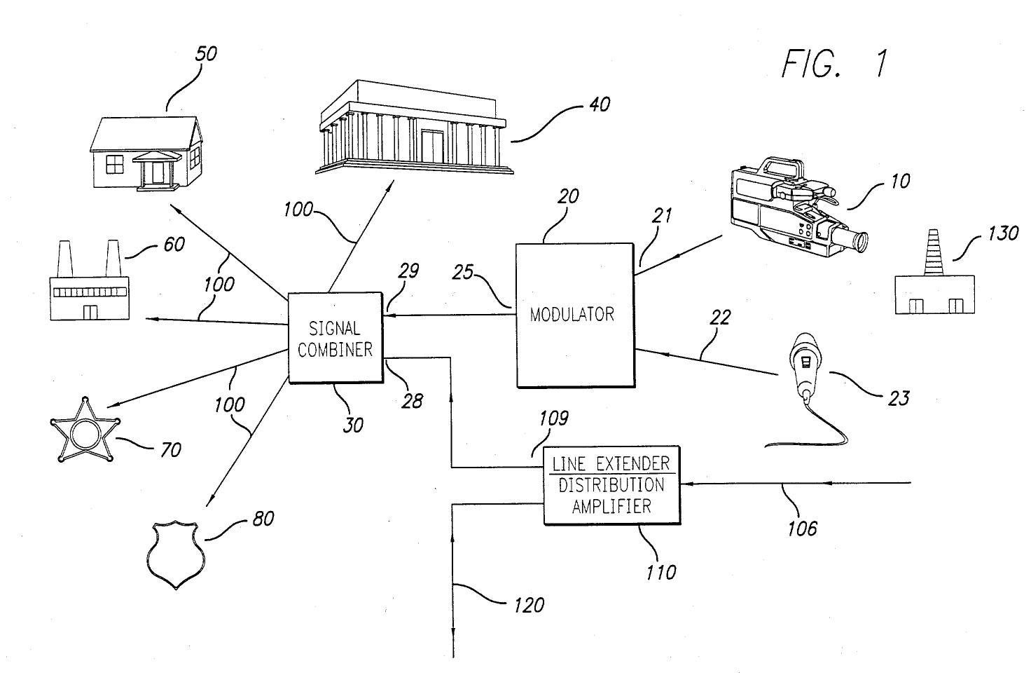

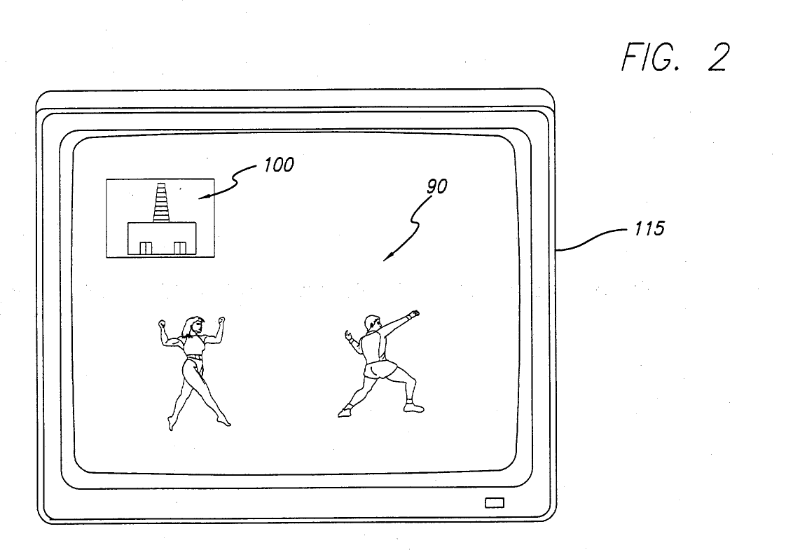

The above advantages and subsequent description will be more readily understood by reference to the following drawings. FIG. 1 is a block diagram showing the surveillance system configuration. FIG. 2 is a pictorial showing a television screen with picture-in-picture (PIP) capabilities displaying a CATV channel in the foreground and the surveillance channel in the PIP window.

### DETAILED DESCRIPTION OF THE INVENTION

In FIG. 1 RF modulator 20 as shown with a composite input video signal 21 coming from television camera 10 that is viewing an electrical power station 130. An audio input signal 22 to modulator 20 coming from microphone 23 with an output signal 25 of modulator 20 supplying a modulated RF signal to input 29 of signal combiner 30. Additionally in FIG. 1 CATV RF signals 106 being supplied to CATV cable company line extender or distribution amplifier 110 also with bi-directional signals from/to CATV Cable Company 120. Signal combiner 30 with input 28 coming from line extender or distribution amplifier 110 output 109. Output of signal combiner 30 comprising of a singularity or multiplicity for a plurality of coaxial cables 100 to government security services 40, residences 50, factories 60, police services 70 and fire services 80. It being understood that one of the features of the invention is the fact that the number and kinds of video displays are extendable and can supply a multiplicity of observers

As shown in FIG. 2. a conventional television receiver 115 with a foreground display 90 displaying a television show 90 with a picture-in-picture (PIP) 100 showing a surveillance site simultaneously with a broadcast television show 90. It being understood that one of the features of the invention is that a multiplicity of PIP panels 100 can be displayed simultaneously with a multiplicity of views 90 by using partitioned or multiplexed electronics.

The advantages of a visual and audible surveillance system using cable television equipment as a means of distribution are described hereafter:

1: The Apparatus in FIG. 1 10 is a commercially available off-the-shelf video camera that converts visual scenes into composite video, i.e. a signal that contains video, and synchronization signals, that can then be viewed on a commercially available television receiver, or stored on a videocassette recorder (VCR), with composite video and audio inputs. Additionally, the camera may be black and white or color, sensitive to other regions of the electromagnetic spectrum, such as infrared, which enables imagining at night, heat emitting objects or other spectrum defined viewing of images.

2: The apparatus in FIG. 1 20 is a commercially available off-the-shelf radio frequency (RF) modulator that converts composite video and audio into a modulated RF signal that can be transmitted over existing CATV distribution systems and received by commercially available television receivers.

3: The apparatus in FIG. 1 110 is a line extender or distribution amplifier that is commonly used by CATV companies to amplify RF signals and distribute them to CATV subscribers. Further, the line amplifier or distribution amplifier may have bi-directional signal capabilities that enable information to be transmitted back to the CATV Company or law enforcement agencies.

4: The apparatus in FIG. 1 30 is a commercially available RF signal combiner whose function is to combine the RF signal being transmitted by the CATV Company with the RF signal from the RF modulator 20 of FIG. 1 that is modulating the video and audio signals from the site of FIG. 1 130 being surveyed. This enables the combined signals to be received by any viewer of FIG. 1 40, 50, 60, 70, or 80.

5: The apparatus in FIG. 2 115 is a commercially available television receiver that has the ability, without modification, to display, the CATV commercially broadcast television channel or site under surveillance FIG. 2 90 or to simultaneously display either the CATV commercially broadcast television channel or site under surveillance FIG. 2 90 via a commercially available television receiver equipped with picture-in-picture (PIP) FIG. 2 100 capability

While the invention has been described in its preferred embodiments, it is to be understood that the words which have been used are words of description rather than limitation and that changes may be made within the preview of the appended claims without departing from the true scope and spirit of the invention in its broader aspects.

For example, a commercially available television receiver need not be used to view the surveyed area as any receiver with RF receiving capabilities may be used and need not have visual capabilities but may have pattern recognition capabilities that would automatically annunciate a deviation from a normal scene. Additionally, one need not have a separate RF modulator and combiner as a CATV company may already have this capability in its existing line or distribution amplifiers.

What is claimed is:

1: A plurality of visual, acoustical or electromechanical surveillance equipment using cable television (CATV) plant distribution means and equipment comprising in combination of: radio frequency modulators, radio frequency combiners, CATV line extenders, bi-directional distribution amplifiers, video cameras with various spectral responses, microphones, cables, power supplies, television and special processing receivers, with or without picture-in-picture (PIP) capabilities, and associated electromechanical equipment whose primary function in combination is surveillance.

2. The apparatus of claim 1 wherein the video cameras with various spectral responses and acoustical collection sources may be connected to the RF modulators, combiners, line amplifiers, and distribution amplifiers via cable, optics, or other communication means.

3. The apparatus of claim 1 wherein the RF modulator is capable of modulating video and acoustical sources into a combined signal suitable for insertion into CATV signal combiner, or other carrier, for reception by television receiving equipment used for viewing or processing.

4. The apparatus of claim 1 wherein the combiner combines incoming CATV broadband signals with the output of an RF surveillance modulator whose inputs are video and audio signals from cameras and acoustical sources that are surveying selected sites.
